(19) United States
(12) Patent Application Publication
(10) Pub. No.: US 2025/0196382 A1
(43) Pub. Date: Jun. 19, 2025

(54) RAZOR CARTRIDGES

(71) Applicant: SL Shaveco LLC, Beverly, MA (US)

(72) Inventors: Ralph K. Maider, JR., Milton, MA (US); Andre Chmyrov, Taunton, MA (US)

(21) Appl. No.: 18/541,287

(22) Filed: Dec. 15, 2023

(51) Int. Cl. B26B 21/40; B26B 21/22

(52) U.S. Cl. CPC B26B 21/4031; B26B 21/4018; B26B 21/4025; B26B 21/4081; B26B 21/222

(57) ABSTRACT

Razor cartridges are disclosed that include a housing, a plurality of blades disposed within an open area of the housing, and a pair of clips disposed on opposite sides of the open area and configured to secure the blades in the housing, each clip having a first leg and a second leg. The housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to allow visual inspection of a bent portion of the corresponding second leg.

### BACKGROUND

Shaving systems often consist of a handle and a cartridge in which one or more blades are mounted in a plastic housing. In some cases, the blades are held in place in the housing by a pair of clips, mounted at opposite ends of the length of the blades. In addition to holding the blades in place, the clips can also define the blade exposure. In some cases, the clips are fabricated from aluminum or any other sacrificial electrochemical element or alloy that will prevent the blades from corroding.

Each of the clips may be wrapped around the outer surface of the housing or secured in place by being inserted through holes in the housing in the manner of a staple. In both cases, the legs of the clips that extend below the housing are bent around the housing, again in a staple-like shape. Inspection of the clips is an important step in manufacturing, to ensure that the clips have been properly assembled onto the cartridge.

### SUMMARY

In general, the present disclosure pertains to razor cartridges (also known as blade units), and to shaving systems and replaceable shaving assemblies that include such cartridges.

In one aspect, the disclosure features a razor cartridge comprising: an elongated housing defining a central open area, and having, in use, a leading edge and a trailing edge, a plurality of blades disposed within the open area of the housing, and a pair of clips disposed on opposite sides of the open area and configured to secure the blades in the housing, each clip having a first leg and a second leg. The housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to allow visual inspection of a bent portion of the corresponding second leg.

Some implementations include one or more of the following features.

The channel may be positioned adjacent the trailing edge and the slot is positioned adjacent the leading edge.

The open end of the slot may be configured to face a side surface of the housing, or, alternatively, to face the leading edge of the housing.

The cartridge may further include an elastomeric guard positioned along the leading edge of the housing and the housing may further include a pair of wings extending outboard of the elastomeric guard.

The slot may have a first width outboard of the second leg of the clip and a second, smaller width between an outer surface of the leg and an inner surface of the wing. The first width may be from 0.2 mm to 2.4 mm. The second width may be from 0.2 mm to 1.0 mm.

The razor cartridge may further include a cap extending along one edge of the housing and a guard extending along the opposite long edge, and the slots may be disposed adjacent to ends of the guard and the channels disposed adjacent to ends of the cap.

In another aspect, the disclosure features a shaving system comprising (a) a handle, and (b) a razor cartridge mounted on a distal end of the handle, the razor cartridge comprising (i) an elongated housing defining a central open area, and having, in use, a leading edge and a trailing edge, (ii) a plurality of blades disposed within the open area of the housing, and (iii) a pair of clips disposed on opposite sides of the open area and configured to secure the blades in the housing, each clip having a first leg and a second leg, wherein the housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to allow visual inspection of a bent portion of the corresponding second leg.

In a further aspect, the invention features a method of shaving comprising contacting the skin with a razor cartridge comprising (a) an elongated housing defining a central open area, and having, in use, a leading edge and a trailing edge, (b) a plurality of blades disposed within the open area of the housing, and (c) a pair of clips disposed on opposite sides of the open area and configured to secure the blades in the housing, each clip having a first leg and a second leg, wherein the housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to allow visual inspection of a bent portion of the corresponding second leg.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a razor cartridge according to one implementation.

FIG. 2 is a top view of the razor cartridge shown in FIG. 1.

FIG. 2A is an enlarged view of the right corner of the cartridge shown in FIG. 2.

FIG. 3 is a side view of the cartridge.

FIG. 4 is a bottom view of the cartridge.

FIG. 5 is a perspective view of the housing of the cartridge shown in FIG. 1.

FIG. 6 is a top view of the housing.

FIG. 7 is a bottom view of the housing.

FIG. 8 is a perspective view of a razor cartridge according to another implementation.

FIG. 9 is a top view of the razor cartridge shown in FIG. 8.

FIG. 10 is a front view of the cartridge.

FIG. 11 is a bottom view of the cartridge.

FIG. 12 is a perspective view of the housing of the cartridge shown in FIG. 8.

FIG. 13 is a front view of the housing.

FIG. 14 is a top view of the housing.

FIG. 15 is a bottom view of the housing.

FIG. 16 is an enlarged partial front view of the housing of a razor cartridge according to another alternative implementation.

### DETAILED DESCRIPTION

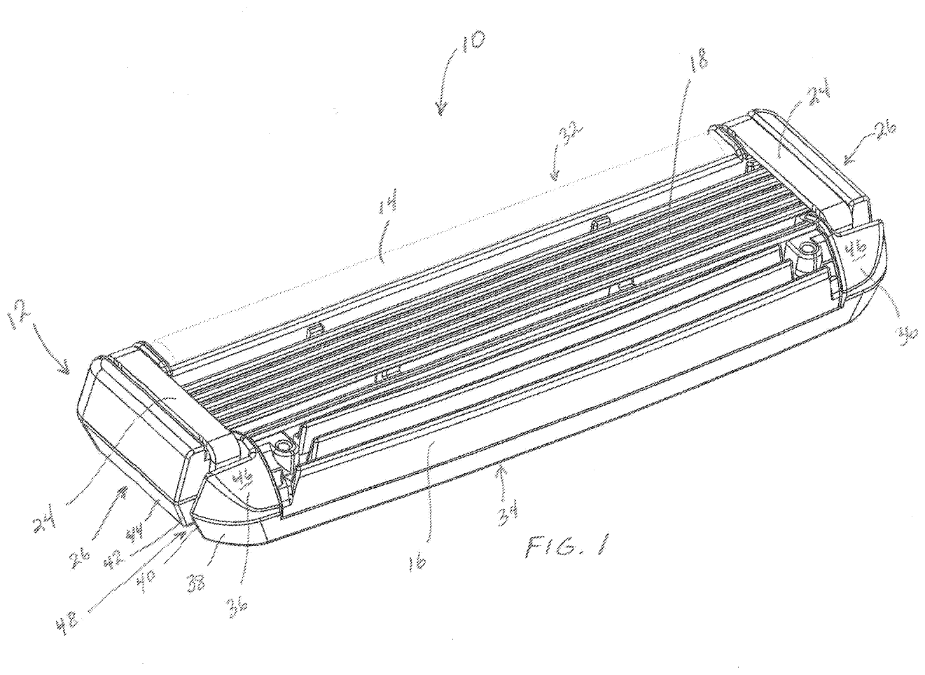

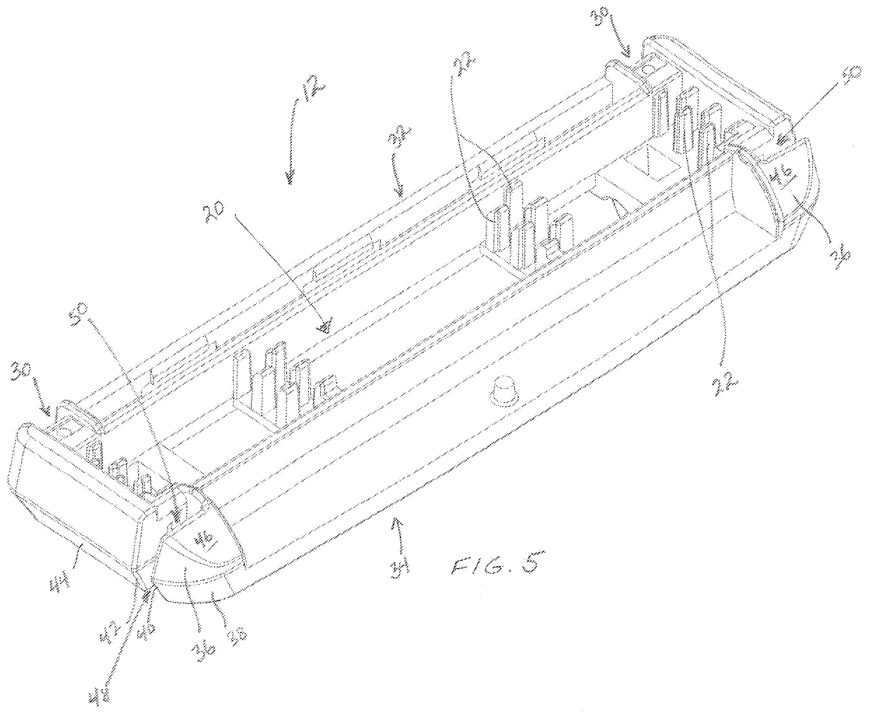

FIG. 1 shows a razor cartridge 10 that includes a housing 12, a cap 14, a guard 16, and a plurality of blades 18 disposed between the cap 14 and guard 16. Blades 18 are disposed in a central open area 20 of the housing 12, shown in FIG. 5, and are positioned by alternating blade positioning elements 22 (FIG. 5).

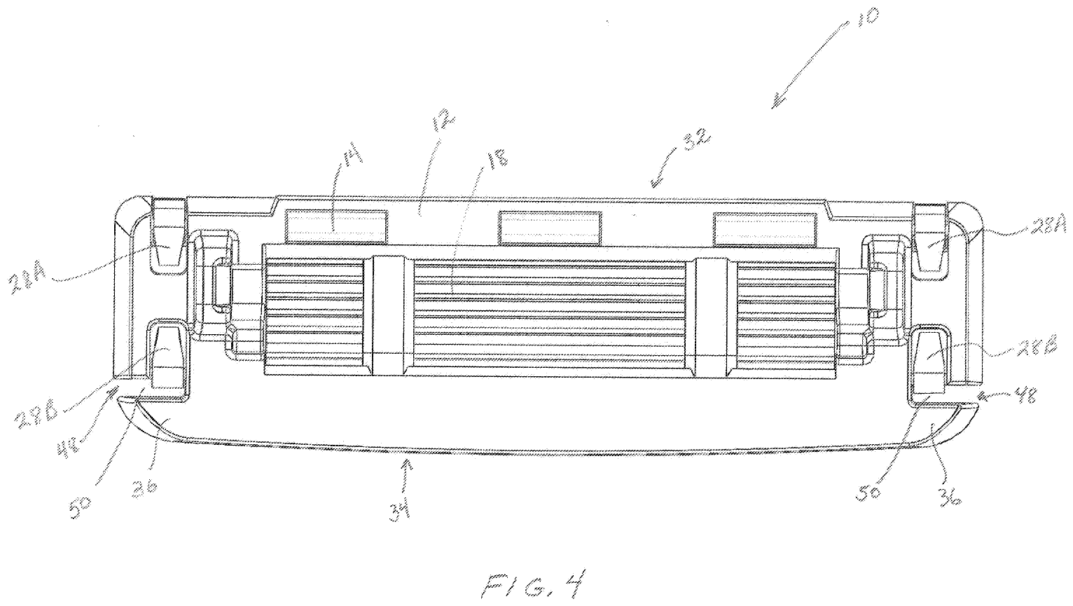

A pair of clips 24, disposed just inboard of the short ends 26 of the housing 12, maintain the blades in the desired blade geometry and retain the blades securely in the housing. As shown in FIG. 4, each clip has a pair of legs 28a, 28b. Referring to FIG. 5, an open channel 30 is provided in the trailing edge 32 of the housing 12, positioned on either side of the cap 14. The upper leg 28a of each clip is received in channel 30 and wrapped around the housing to be secured at the bottom of the housing in staple fashion as shown in FIG. 4.

The other leg of the clip, leg 28b, is adjacent the leading edge 34 of the cartridge and thus is secured in a different manner such that the clip is not exposed for contact between the user's skin and the legs 28b. Each leg 28b extends through a slot 50, one side of which is defined by a wing 36 of the housing, which extends beyond the sides of the guard 16.

Wings 36 have a leading surface 38 that curves smoothly from the leading edge 34 of the cartridge to a distal edge 40 that faces and is aligned with a distal edge 42 of a side surface 44 of the housing 12. The wings 36 also include a broad surface 46 that can carry a texture or pattern (not shown) to enhance the aesthetic and/or tactile characteristics of the cartridge.

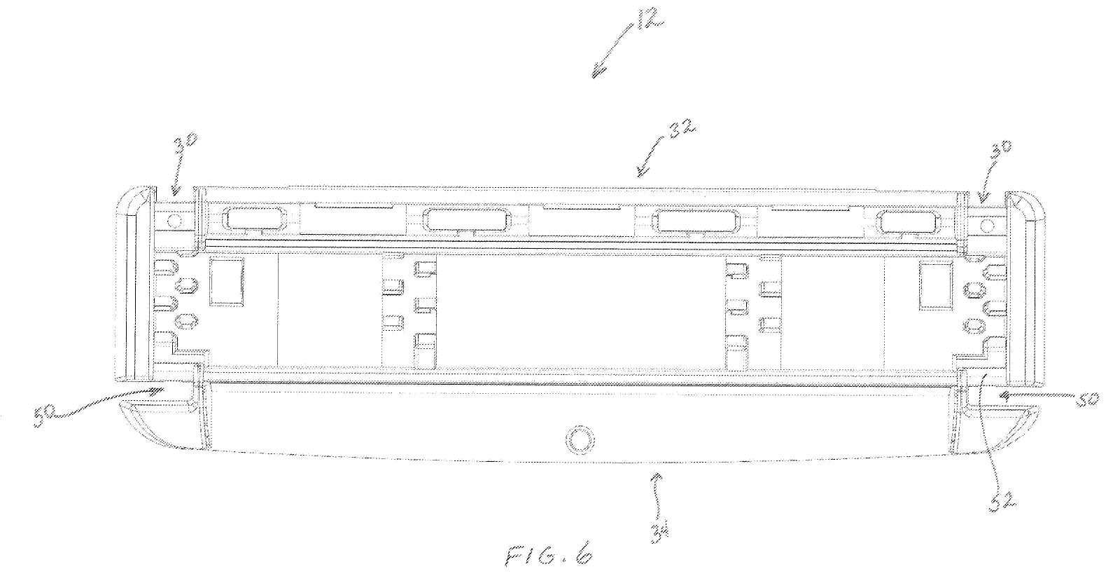

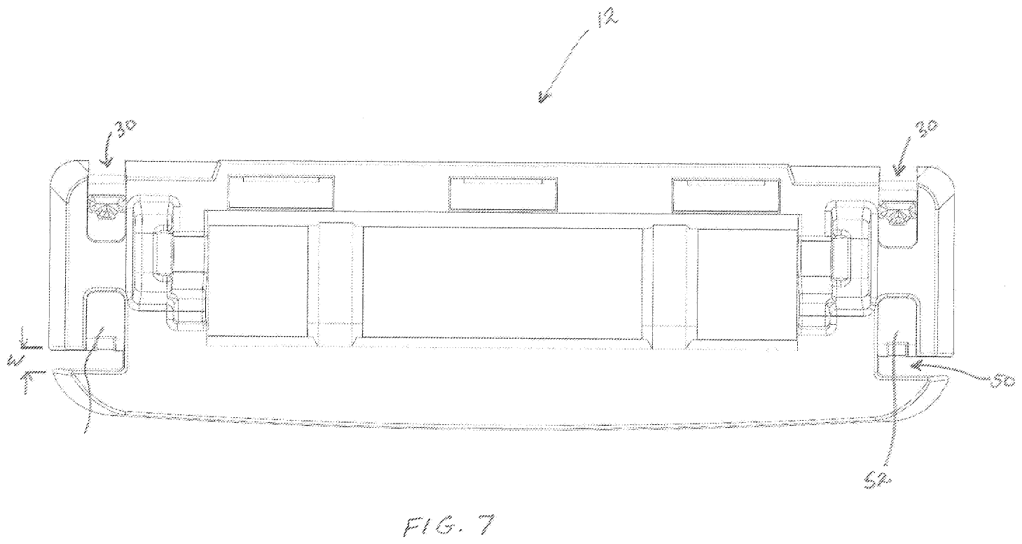

Edges 34 and 42 face each other across a gap 48 that defines the entrance to the slot 50. Slot 50 extends parallel to the longitudinal axis of the cartridge, as best seen in FIG. 6. Slot 50 is open-ended, at gap 48, allowing debris to be easily rinsed from the slot. Immediately above the slot 50, a channel 52 is formed in the housing, wrapping around the housing from front to back as can be seen in FIGS. 6 and 7. Channel 52 is configured to receive leg 28b of the clip 24 in seating engagement and thus allow leg 28b to be wrapped around and secured to the bottom of the housing 12 in staple fashion as shown in FIG. 4.

Advantageously, the configuration of slot 50 allows shaving debris and soap to be rinsed out of the area surrounding leg 28b.

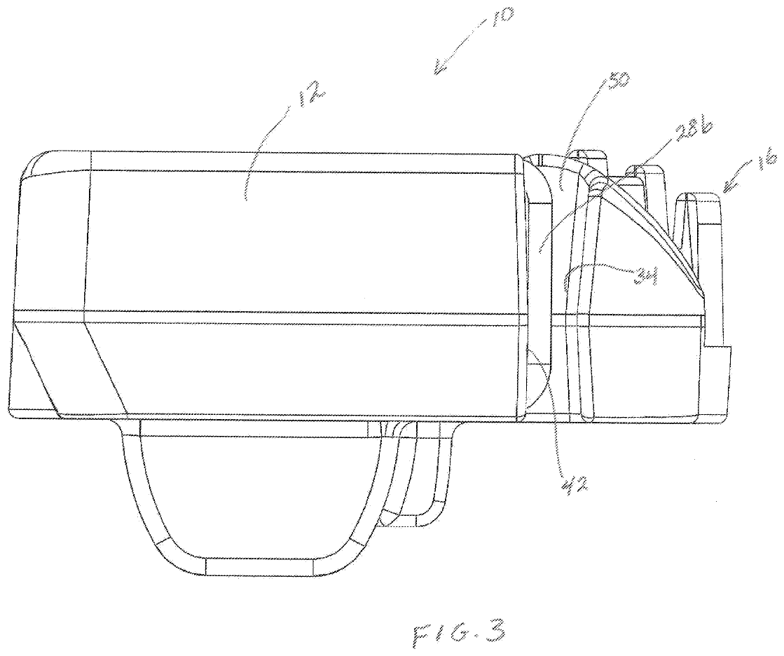

Moreover, as can be seen best in FIG. 3, during assembly the gap 48 can be used to visualize the position of leg 28b (e.g., using an inspection camera) through slot 50 to insure proper securement of leg 28b to the bottom of the housing 12 (FIG. 4). The slot allows light to be directed at the leg 28b for improved inspection. Being able to inspect the clip from the side as well as from the bottom of the housing also improves the inspection process.

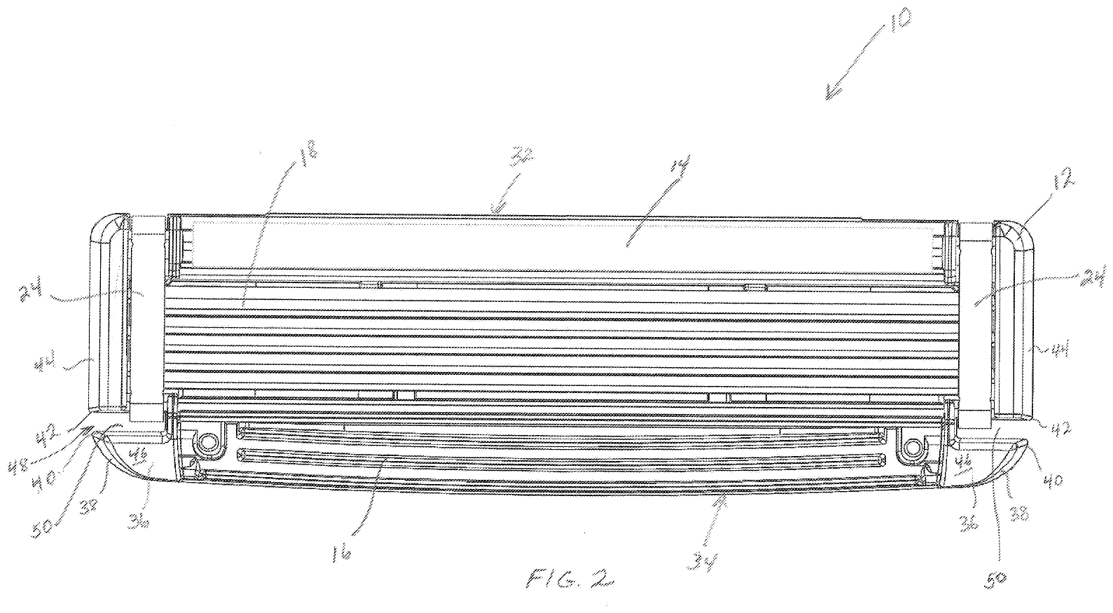

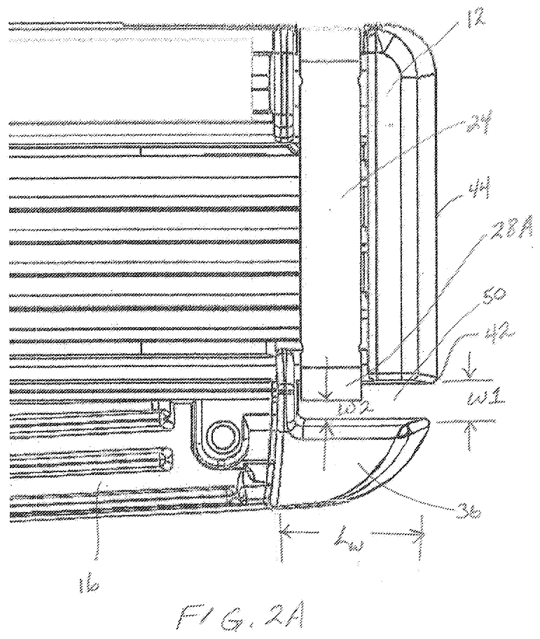

Referring to FIG. 2A, the portion of slot 50 that extends outboard of the leg 28b to the gap 48 has a width W1 that is sufficient to allow inspection of the installation of leg 28b. Width W1 may be, for example, from 0.2 mm to 2.4 mm, and in some implementations from 0.5 mm to 1.5 mm.

Because the leg 28a protrudes into the slot 50 the width W2 of the slot 50 where the slot extends between the leg 28a and wing 36 is less than W1 by the distance to which leg 28a protrudes into the slot. It is desirable that width W2 be sufficient to provide good rinsability of debris from the area of leg 28a. Width W2 may be, for example, from 0.2 mm to 1.0 mm, and in some implementations from 0.5 mm to 0.8 mm.

Referring again to FIG. 2A, as noted above wing 36 generally extends longitudinally from the outer edge of guard 16 to the side surface 44 of housing 12. The length Lw of the wing 36 may be, for example, from 2.5 mm to 4.0 mm, and in some implementations is from 2.3 mm to 4.0 mm.

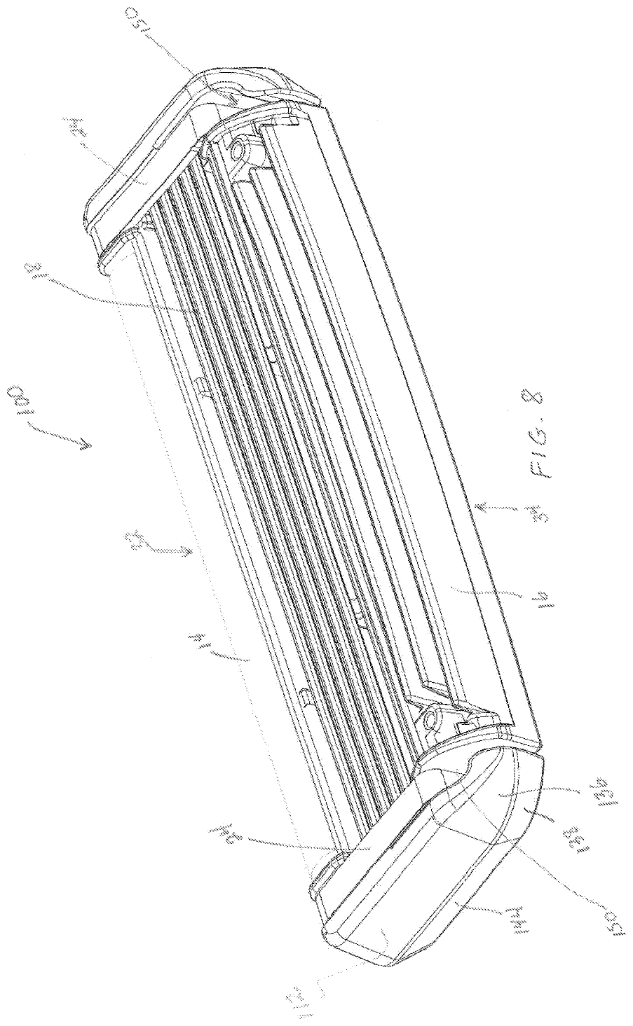

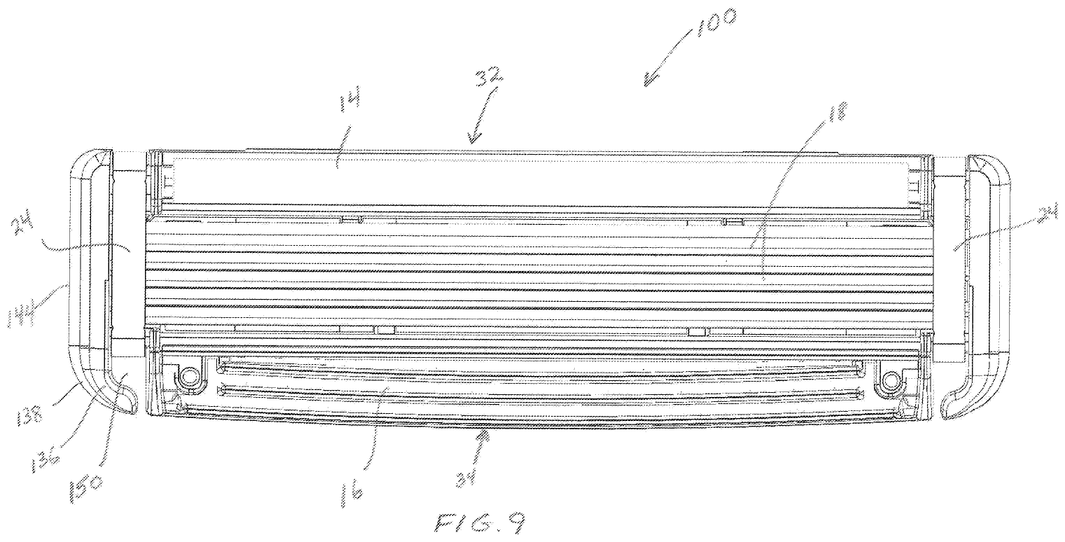

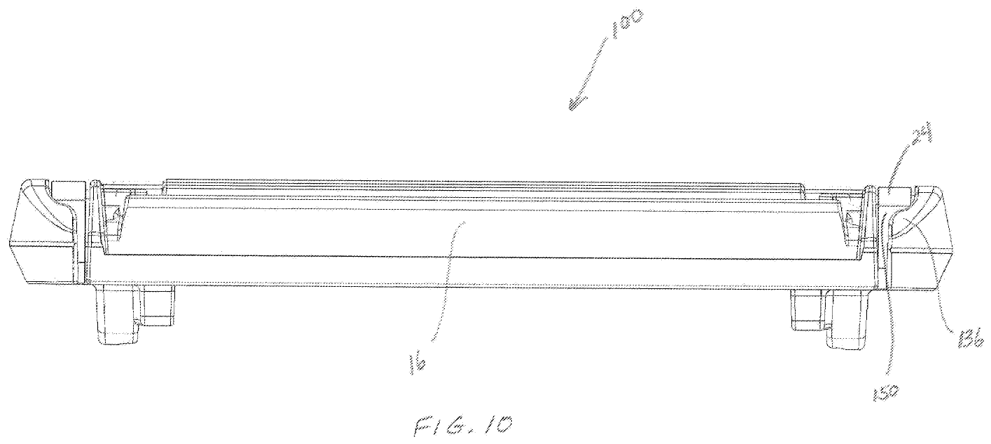

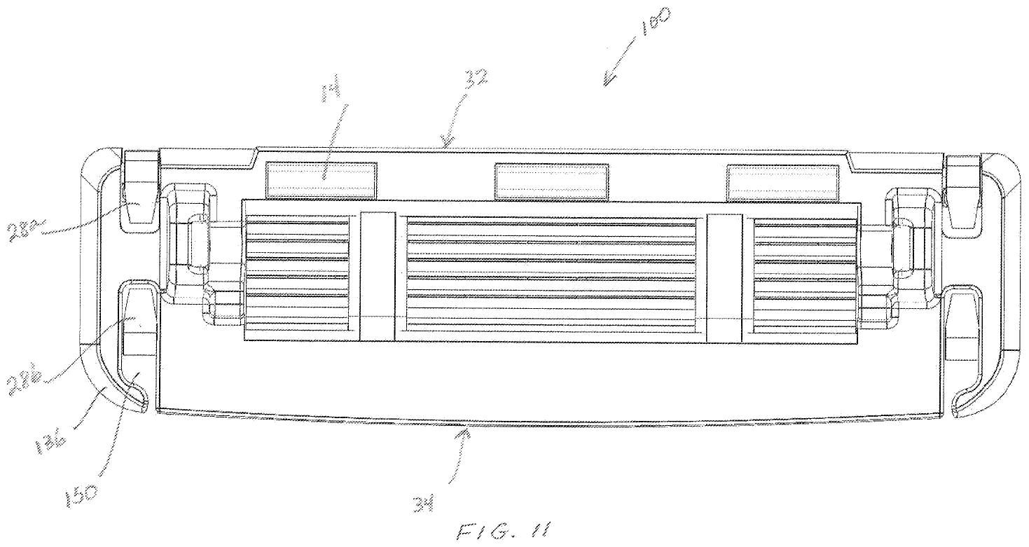

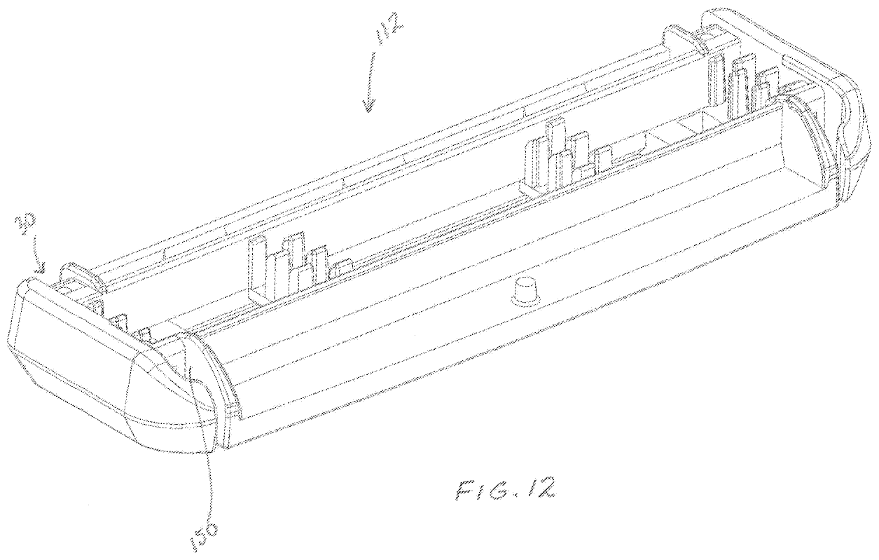

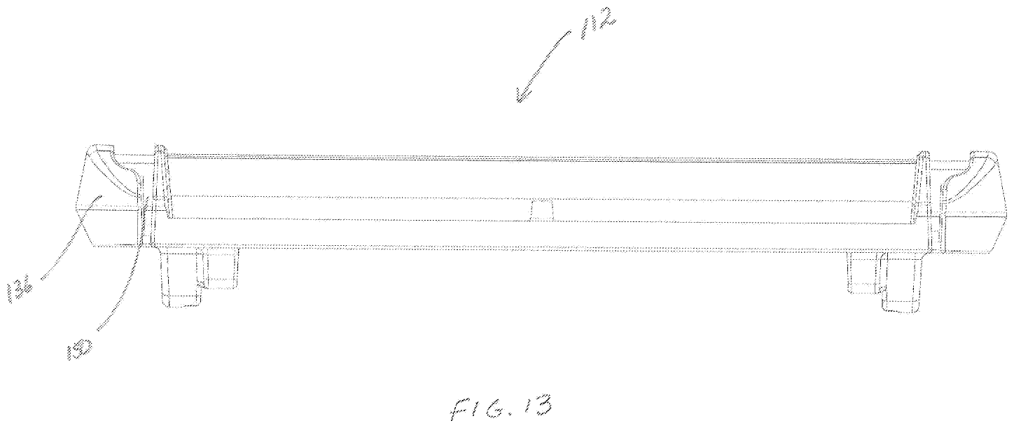

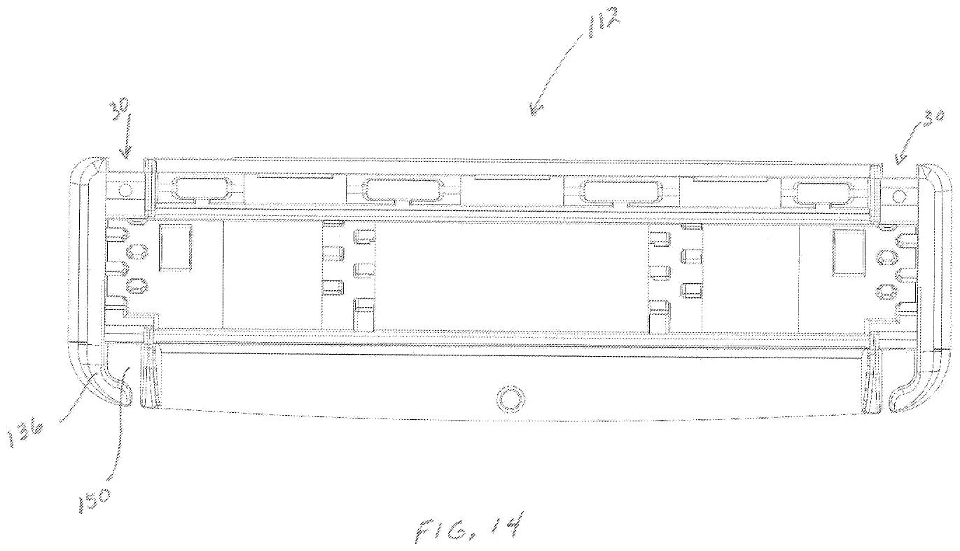

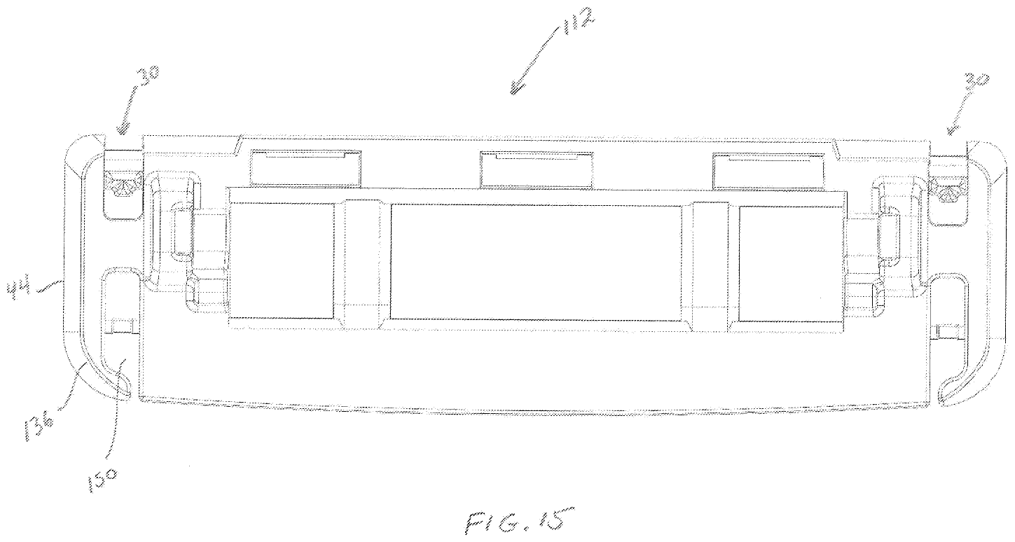

An alternate embodiment is shown in FIGS. 8-15. In this embodiment, a slot 150 is provided that faces the leading edge 34 of the cartridge rather than the side surface of the cartridge. In razor cartridge 100 wings 136 extend from the side surfaces 144 of the housing 112. Like the wings 36 discussed above, wings 136 include a smoothly curved leading surface 138.

Like slot 50 discussed above, slot 150 includes a gap 148 through which inspection of the clip installation can be performed, e.g., using an inspection camera. The slot 150 also provides good rinsability around the front of the clip, preventing build up of shaving debris and soap in this area.

### OTHER EMBODIMENTS

A number of embodiments have been described. Nevertheless, it will be understood that various modifications may be made without departing from the spirit and scope of the disclosure.

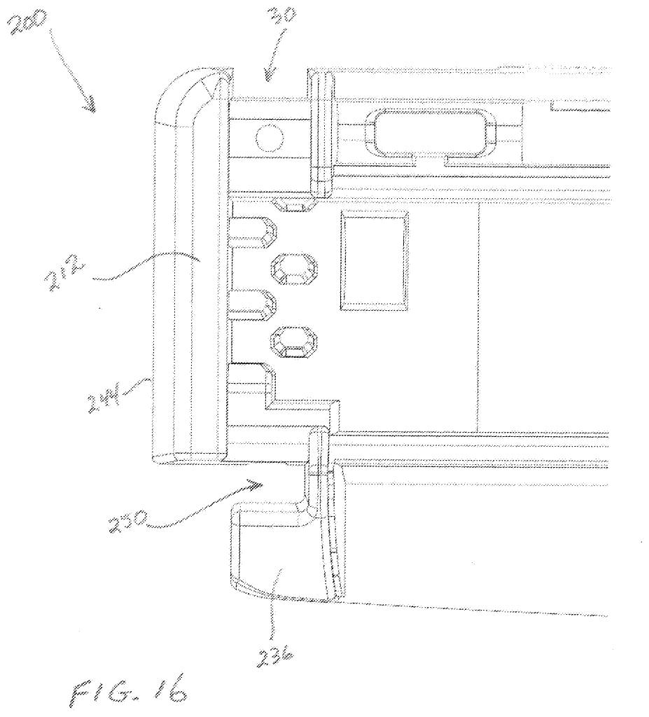

In some cases, the wings may have a different shape, and/or may extend further or less far from the outer edges of the guard. For example, in the implementation shown in FIG. 16 a razor cartridge 200 has a housing 212 that includes a wing 236 that extends only part way towards the side surface 244, providing a shallower slot 250.

Accordingly, other embodiments are within the scope of the following claims.

1. A razor cartridge comprising:
an elongated housing defining a central open area, and having, in use, a leading edge and a trailing edge,
a plurality of blades disposed within the open area of the housing, and
a pair of clips disposed on opposite sides of the open area and configured to secure the blades in the housing, each clip having a first leg and a second leg,
wherein the housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to face the leading edge of the housing and to allow visual inspection of a bent portion of the corresponding second leg.

2. The razor cartridge of claim 1, wherein the channel is positioned adjacent the trailing edge and the slot is positioned adjacent the leading edge.

3. (canceled)

4. (canceled)

5. The razor cartridge of claim 2 wherein the cartridge further includes an elastomeric guard positioned along the leading edge of the housing and the housing further includes a pair of wings extending outboard of the elastomeric guard.

6. The razor cartridge of claim 5 wherein the slot has a first width outboard of the second leg of the clip and a second, smaller width between an outer surface of the leg and an inner surface of the wing.

7. The razor cartridge of claim 6 wherein the first width is from 0.2 mm to 2.4 mm.

8. The razor cartridge of claim 6 wherein the second width is from 0.2 mm to 1.0 mm.

9. The razor cartridge of claim 1 further comprising a cap extending along one edge of the housing and a guard extending along the opposite long edge, wherein the slots are disposed adjacent to ends of the guard and the channels are disposed adjacent to ends of the cap.

10. A shaving system comprising:
a handle, and
a razor cartridge mounted on a distal end of the handle, the razor cartridge comprising
an elongated housing defining a central open area, and having, in use, a leading edge and a trailing edge,
a plurality of blades disposed within the open area of the housing, and
a pair of clips disposed on opposite sides of the open area and configured to secure the blades in the housing, each clip having a first leg and a second leg,
wherein the housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to face the leading edge of the housing and to allow visual inspection of a bent portion of the corresponding second leg.

11. A method of shaving comprising contacting the skin with a razor cartridge comprising (a) an elongated housing defining a central open area, and having, in use, a leading edge and a trailing edge, (b) a plurality of blades disposed within the open area of the housing, and (c) a pair of clips disposed on opposite sides of the open area and configured to secure the blades in the housing, each clip having a first leg and a second leg, wherein the housing includes a pair of channels configured to receive the first legs of the clips in seating engagement when each first leg is wrapped around an outer surface of the housing, and a pair of slots configured to receive the second legs and allow a distal end of each second leg to be bent against a lower surface of the housing, each slot having an open end configured to face the leading edge of the housing and to allow visual inspection of a bent portion of the corresponding second leg.
